(19) United States
(12) Patent Application Publication
(10) Pub. No.: US 2023/0166565 A1
(43) Pub. Date: Jun. 1, 2023

(54) Tire Safety Monitoring Line Device

(71) Applicant: Jerry Robinson, Groton, NY (US)

(72) Inventor: Jerry Robinson, Groton, NY (US)

(21) Appl. No.: 17/715,174

(22) Filed: Apr. 7, 2022

Related U.S. Application Data
(60) Provisional application No. 63/284,143, filed on Nov. 30, 2021.

(51) Int. Cl. B60C 11/24; B60C 11/00; B60C 1/00

(52) U.S. Cl. CPC B60C 11/246; B60C 11/0041; B60C 1/0016; B60C 2200/04

(57) ABSTRACT

The present invention relates to a novel tire safety monitoring line device which allows for automatic and continuous tire tread monitoring. The device comprises a plurality of dye-filled or paint-filled capsules embedded within the tire tread at differing tread levels. As the tire tread gets low, the capsules are exposed, breaking open and releasing the dye/paint. Thus, the colors of dye/paint released indicate differing tread levels, which alerts a user as to the tire tread level of their vehicle tire.

### CROSS-REFERENCE TO RELATED APPLICATION

The present application claims priority to, and the benefit of, U.S. Provisional Application No. 63/284,143, which was filed on Nov. 30, 2021 and is incorporated herein by reference in its entirety.

### FIELD OF THE INVENTION

The present invention relates generally to the field of tire monitoring devices. More specifically, the present invention relates to an improved tire monitoring device that immediately alerts users of worn tire treads. The device comprises dye or paint-filled capsules positioned within the tire tread layers which display a specific color when the tire tread becomes worn, which eliminates the guesswork of when to replace worn tires. Accordingly, the present disclosure makes specific reference thereto. Nonetheless, it is to be appreciated that aspects of the present invention are also equally applicable to other like applications, devices and methods of manufacture.

### BACKGROUND

By way of background, the handling performance of a motor vehicle (i.e., vehicle steering, braking and fuel consumption) is affected by the condition of the tires. Specifically, handling performance can be affected by improper fire inflation, abnormal fire tread wear, and out of balance conditions. Thus, having worn tire treads on a user's vehicle tires can be incredibly dangerous and would affect the handling performance of the motor vehicle.

Furthermore, new tires are formed with a tread that includes channels through which water, snow, and other environmental debris, commonly found on roads, can pass as the vehicle travels along a public roadway. By allowing the water to enter the channel, the amount of water passing between the roadway surface and the outermost tire surface is minimized, thereby reducing the tendency of the water to lift the vehicle from the roadway surface (i.e., hydroplaning). However, as the tire tread wears down, this channel is minimized, causing poor driving conditions especially during inclement weather. Accordingly, hydroplaning tends to occur more frequently with smooth or low tread tires, which can lead to serious accidents and injuries.

Thus, it is necessary for vehicle owners to be aware of the status of their tire treads. Generally, checking tire treads can be a time-consuming process that many vehicle owners avoid and/or neglect. However, users need to routinely check their tire tread to avoid unsafe driving conditions. Therefore, users require a device that easily allows them to check their tire tread without expensive tools or tedious methods.

Therefore, there exists a long-felt need in the art for a tire safety monitoring line device that continuously monitors a user's tire tread. There is also a long-felt need in the art for a tire tread monitoring device that eliminates the need for users to utilize expensive tools to monitor their tire tread. Further, there is a long-felt need in the art for a tire safety monitoring line device that simplifies the process of monitoring tire tread and allows the monitoring process to be less exhaustive and time consuming. Moreover, there is a long-felt need in the art for a device that monitors a user's tire tread automatically and continuously. Further, there is a long-felt need in the art for a tire tread monitoring device that can be used for monitoring a user's vehicle tire treads on any type of vehicle known in the art. Finally, there is a long-felt need in the art for a tire safety monitoring line device that offers a way for any vehicle owner, commercial or personal vehicles, to easily monitor their tire tread.

The subject matter disclosed and claimed herein, in one embodiment thereof, comprises a tire safety monitoring line device. The device is designed to continuously and automatically monitor a user's tire tread. The device comprises a plurality of dye-filled or paint-filled capsules positioned within a vehicle tire. The dye-filled or paint-filled capsules are comprised of a variety of different colors and sizes as is known in the art. The capsules are embedded within the tire tread at differing tread levels. As the tire tread gets low, the capsules are exposed, breaking open and releasing the dye. Thus, the colors of dye released indicate differing tread levels, which alerts a user as to the tire tread level of their vehicle tire.

In this manner, the tire safety monitoring line device of the present invention accomplishes all of the forgoing objectives and provides users with a device that automatically and continuously monitors tire tread levels. The device allows a user to simply and efficiently monitor tire tread levels on any vehicle. The device eliminates expensive tools and time-consuming processes and offers a way for any vehicle owner, commercial or personal vehicles, to easily monitor their tire tread.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a tire safety monitoring line device. The device is designed to automatically and continuously monitor a user's tire tread on any vehicle. The device comprises a plurality of dye-filled or paint-filled capsules positioned within a vehicle tire. The dye-filled or paint-filled capsules are comprised of a variety of different colors and sizes as is known in the art. Specifically, the capsules can be any suitable shape and size as is known in the art as long as they contain an interior cavity which can be filled with dye and/or paint. The capsules are embedded within the tire tread at differing tread levels. As the tire tread gets low, the capsules are exposed, breaking open and releasing the dye. Thus, the colors of dye released indicate differing tread levels, which alerts a user as to the tire tread level of their vehicle tire.

In yet another embodiment, the capsule is created via standard encapsulation methods. Specifically, the dye or paint can be encapsulated with a soft capsule shell by any suitable method known in the art, such as a standard rotary die soft gelatin capsule machine, a plate process, a seamless capsule machine, and a non-standard rotary die machine, which uses extrusion technology. Once encapsulated, the soft capsule shell then utilizes high frequency, ultrasonic, or induction welding to seal the capsules.

In yet another embodiment, the tire safety monitoring line device is manufactured from heat-sealable plastic or polymers, such as polypropylene or acrylonitrile-butadiene-styrene (ABS) and is sealed via high frequency, ultrasonic, or induction welding techniques.

In yet another embodiment, the tire safety monitoring line device is manufactured from a material that is water resistant.

In yet another embodiment, the amount of material present in the soft capsule shell is approximately the amount needed to yield a soft capsule shell sufficient to encapsulate and protect the liquid fill, (i.e., dye and/or paint).

In yet another embodiment, the liquid fill present in the soft capsule shell is shown in an amount of at least about 20% by weight, more preferably at least about 25%, and most preferably at least about 30% by weight of the shell. The liquid fill is present in the soft capsule shell in an amount of, at most, about 85% by weight, preferably, at most, about 70%, more preferably, at most, about 65%, and most preferably, at most, about 60% by weight of the soft capsule shell.

In yet another embodiment, the liquid fill can be any suitable dye or paint as is known in the art, such as cyrstal violet, safranin, basic fuchsin and methylene blue, etc., or any other pigment as is known in the art.

In yet another embodiment, the vehicle tire may also include multiple rubber levels of differing colors, such that as the tire tread wears down, the colored rubber layers are exposed which indicate to a user that the tire treads are worn.

In yet another embodiment, the dye or paint colors indicate how worn the tire tread is. For example, a yellow color can warn a user that the tire tread is becoming worn, while a red color can indicate that the tire tread is extremely worn down and the tires need to be immediately replaced.

In yet another embodiment, a method of monitoring a user's tire tread is described. The method includes the steps of providing a plurality of paint-filled or dye-filled capsules, wherein the dye or paint is encapsulated with a soft capsule shell by any suitable method known in the art, such as via a standard rotary die soft gelatin capsule machine, a plate process, a seamless capsule machine, or a non-standard rotary die machine. The soft capsule shell then utilizes high frequency, ultrasonic, or induction welding to seal the capsules. The method also comprises positioning the plurality of capsules within a vehicle's tire tread, such that the plurality of capsules are stacked within different layers of tire tread. Further, the method comprises releasing a specific color upon breaching different layers of tire tread. The capsules are exposed when the tire tread is low, therefore breaking open and releasing the dye once contact has occurred. Finally, identifying different colors which indicate differing tread levels, which warn a user of the tread's status.

In yet another embodiment of the present invention, a tire safety monitoring line device is disclosed for continuously and automatically monitoring a user's tire tread. The device comprises a plurality of dye-filled or paint-filled capsules positioned within a vehicle tire. The dye-filled or paint-filled capsules are comprised of a variety of different colors and sizes as is known in the art, and are created using standard encapsulation and sealing methods for soft capsule shells. Once encapsulated, the capsules are embedded within the tire tread at differing tread levels. As the tire tread wears down, the capsules are exposed, breaking open and releasing the dye. Thus, the colors of dye released indicate differing tread levels, which alerts a user as to the tire tread level of their vehicle tire. The device eliminates the need for expensive tools and time-consuming processes, and allows any vehicle owner, of commercial or personal vehicles, etc., to easily and efficiently monitor their tire tread.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the tire safety monitoring line device of the present invention disclosing the colored rubber layer underneath the main treads, as well as the plurality of paint or dye-filled capsules within the treads, in accordance with the disclosed architecture;

FIG. 2 illustrates a perspective view of another embodiment of the tire safety monitoring line device of the present invention wherein the dye color starts to be revealed when the tire tread is worn in accordance with the disclosed architecture;

FIG. 3 illustrates a perspective view showing how the dye from the tire safety monitoring line device of the present invention shows through when the tire tread is worn in various areas in accordance with the disclosed architecture;

FIG. 4 illustrates a perspective view showing how the dye from the tire safety monitoring line device of the present invention shows through when the tire tread is worn in various areas in accordance with the disclosed architecture;

FIG. 5 illustrates a perspective view of one embodiment of the tire safety monitoring line device of the present invention in use in accordance with the disclosed architecture; and

FIG. 6 illustrates a flowchart showing the method of monitoring a user's tire tread automatically and continuously in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a tire safety monitoring line device that continuously and automatically monitors a user's tire tread. There is also a long-felt need in the art for a tire tread monitoring device that eliminates the need for users to utilize expensive tools to monitor their tire tread. Further, there is a long-felt need in the art for a tire safety monitoring line device that simplifies the process of monitoring tire tread and allows the monitoring process to be less exhaustive and time consuming. Moreover, there is a long-felt need in the art for a tire tread monitoring device that can be used for monitoring a user's vehicle tire treads on any type of vehicle known in the art. Finally, there is a long-felt need in the art for a tire safety monitoring line device that offers a way for any vehicle owner, commercial or personal vehicles, to easily monitor their tire tread.

The present invention, in one exemplary embodiment, is a novel tire safety monitoring line device comprising a plurality of dye-filled or paint-filled capsules embedded within a vehicle's tire tread at differing tread levels. As the tire tread wears down, the capsules are exposed, breaking open and releasing the dye. Thus, the colors of dye released indicate differing tread levels, which alerts a user as to the tire tread level of their vehicle tire. The present invention also includes a novel method of monitoring a user's tire tread. The method includes the steps of providing a plurality of paint-filled or dye-filled capsules, which are then sealed. The method also comprises positioning the plurality of capsules within a vehicle's tire tread, such that the plurality of capsules are stacked within different layers of tire tread. Further, the method comprises releasing a specific color upon breaching different layers of tire tread. Finally, identifying different colors which indicate differing tread levels, which warn a user of the tread's status.

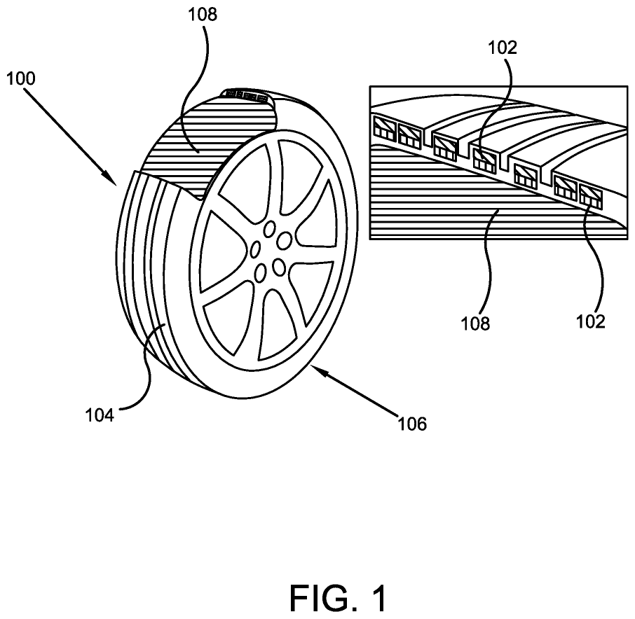

Referring initially to the drawings, FIG. 1 illustrates a perspective view of one embodiment of the tire safety monitoring line device 100 of the present invention. In the present embodiment, the tire safety monitoring line device 100 is an improved tire tread monitoring device that automatically and continuously monitors tire tread. The device 100 is especially designed to allow any vehicle owner, commercial or personal vehicles, or any other suitable user as is known in the art, to easily monitor tire tread. More specifically, the device 100 comprises a plurality of dye-filled or paint-filled capsules 102 embedded within the tire tread 104 of a vehicle tire 106. The vehicle tire 106 can be any suitable tire for any suitable vehicle as is known in the art. Further, any suitable number of capsules 102 can be utilized depending on the needs and/or wants of a user. Additionally, multiple capsules 102 can be placed at each tread layer or a single capsule 102 can be embedded within the tread layer depending on the needs and/or wants of a user.

The dye-filled or paint-filled capsules 102 are comprised of a variety of different colors and sizes as is known in the art. Specifically, the capsules 102 can be any suitable shape and size as is known in the art, as long as they contain an interior cavity which can be filled with dye and/or paint, or any other suitable pigmented liquid.

Typically, the capsules 102 are created via standard encapsulation methods. Specifically, the dye or paint fill can be encapsulated with a soft capsule shell by any suitable method known in the art, such as a standard rotary die soft gelatin capsule machine, a plate process, a seamless capsule machine, and a non-standard rotary die machine, which uses extrusion technology, etc., or any other suitable process as is known in the art. Once encapsulated, the soft capsule shell then utilizes high frequency, ultrasonic, or induction welding, etc., or any other suitable method to seal the capsules to prevent leakage.

The tire safety monitoring line device 100 is typically manufactured from heat-sealable plastic or polymers, such as polypropylene or acrylonitrile-butadiene-styrene (ABS), or any other suitable material as is known in the art, such as but not limited to, acrylic, polycarbonate, polyethylene, thermoplastic, low density polyethylene, medium density polyethylene, high density polyethylene, polyethylene terephthalate, polyvinyl chloride, polystyrene, polylactic acid, acetal, gelatin, etc. Generally, the tire safety monitoring line device 100 is also manufactured from a material that is water resistant or water permeable, or the soft capsule shell 102 comprises a coating that is water resistant or water permeable.

Furthermore, the amount of material present in the soft capsule shell 102 is approximately the amount needed to yield a soft capsule shell 102 sufficient to encapsulate and protect the liquid fill, (i.e., dye and/or paint). Specifically, the soft capsule shell 102 can be any suitable size and shape as is known in the art, as long as the soft capsule shell 102 can retain an amount of liquid fill to alert a user of low tire tread when dispersed. Further, the soft capsule shell must be of a thickness to be durable enough to withstand the manufacturing and processing techniques and not leak, but also thin enough to break open and expose the dye or paint upon contact with the road or other surface.

Additionally, the liquid fill present in the soft capsule shell 102 is of a sufficient amount to alert a user of low tire tread when dispersed and is typically in an amount of at least about 20% by weight, more preferably at least about 25%, and most preferably at least about 30% by weight of the soft capsule shell. Further, the liquid fill is present in the soft capsule shell in an amount of, at most, about 85% by weight, preferably, at most, about 70%, more preferably, at most, about 65%, and most preferably, at most, about 60% by weight of the soft capsule shell. However, any suitable amount of liquid fill can be present in the soft capsule shell as is known in the art, depending on the wants and/or needs of a user.

Moreover, the liquid fill can be any suitable dye or paint as is known in the art, such as crystal violet, safranin, basic fuchsin and methylene blue, etc., or any other suitable pigmented fluid as is known in the art, based on the needs and/or wants of a user. Furthermore, additional additives can be incorporated with the dye or paint, such as additives, water, plasticizer, etc., or any other suitable additives as is known in the art, depending on the needs and/or wants of a user.

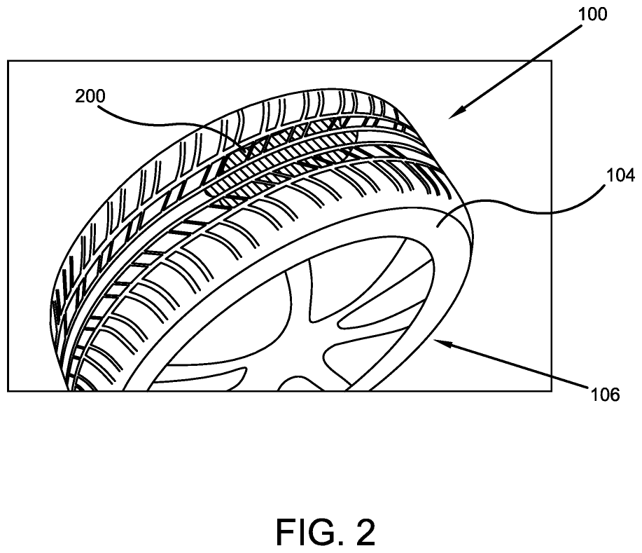

In use, the capsules 102 are embedded within the tire tread 104 at differing tread levels. As the tire tread 104 gets low, the capsules 102 are exposed, breaking open and releasing the dye (shown in FIG. 2). Thus, the colors of dye or paint released indicate differing tread levels, which alerts a user as to the tire tread level of their vehicle tire. Accordingly, the dye or paint colors indicate how worn the tire tread is. Specifically, the dye or paint can be used as identifiers for each tread level, such that a user can identify a specific tread level based on a displayed color. For example, a yellow color can warn a user that the tire tread is becoming worn, while a red color can indicate that the tire tread is extremely worn down and the tires need to be replaced immediately.

In another embodiment, the vehicle tire 106 may also include multiple rubber levels of differing colors 108, such that, as the tire tread 104 wears down, the colored rubber layers 108 are exposed, which also indicates to a user that the tire treads 104 are worn. Thus, the colored rubber layers 108 act in combination with the plurality of dye-filled capsules 102 to alert a user as to the level of their tire treads 104. If a user does not notice the dye marking the worn tire treads 104, the colored rubber layers 108 act as a secondary means of notification for the user.

FIG. 2 illustrates a perspective view of another embodiment of the tire safety monitoring line device 100 of the present invention wherein the dye color 200 starts to be revealed when the tire tread 104 is worn. In the present embodiment, the device 100 comprising the plurality of dye-filled or paint-filled capsules 102 is embedded within a vehicle tire 106. As the tire tread 104 wears down, the capsules 102 are exposed, breaking open and releasing the dye 200. Thus, the colors of dye 200 released indicate differing tread levels, which alerts a user as to the tire tread level of their vehicle tire 106. In this embodiment, only the plurality of dye-filled capsules 102 release dye 200, the vehicle tire 106 does not include colored rubber layers (as shown in FIG. 1).

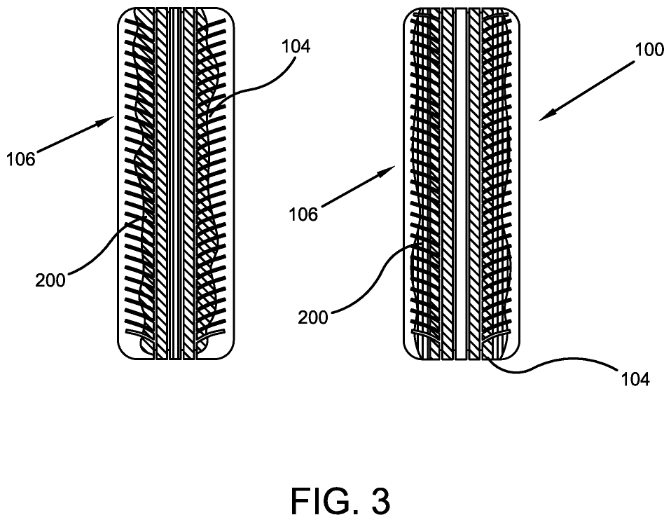

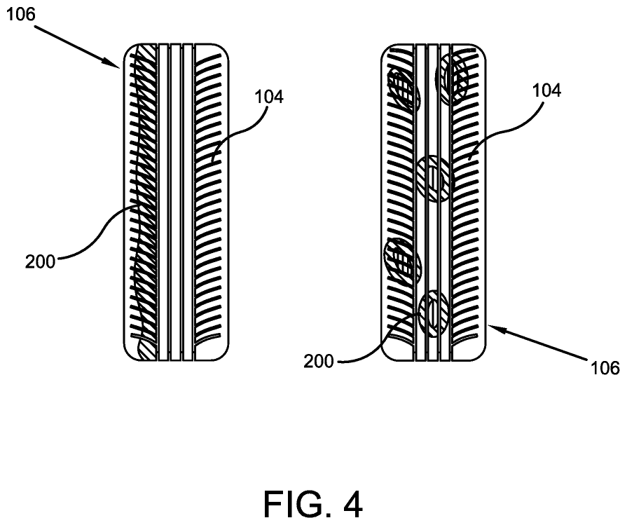

FIGS. 3-4 illustrate a perspective view showing how the dye 300 from the tire safety monitoring line device 100 of the present invention shows through when the tire tread 104 is worn in various areas along the vehicle tire 106. As stated supra, the capsules 102 of the tire safety monitoring line device 100 are embedded within the tire tread 104 at differing tread levels. As the tire tread 104 gets low, the capsules 102 are exposed, breaking open and releasing the dye. Thus, the colors of dye or paint released indicate differing tread levels, which alerts a user as to the tire tread level of their vehicle tire.

Accordingly, the dye or paint colors indicate how worn the tire tread is. Specifically, the dye or paint can be used as identifiers for each tread level, such that a user can identify a specific tread level based on a displayed color. For example, a green color can warn a user that the tire tread is just becoming worn down, a yellow color can warn a user that the tire tread is becoming more worn down than before, while a red color can indicate that the tire tread is extremely worn down and the tires need to be replaced immediately.

As shown in FIGS. 3-4, different areas of the tires 106 can exhibit different wear and tear on their treads 104. Tread wear and tear is based on alignment issues, brake issues, types of tires in use, as well as the surface(s) a user drives on, etc., or any other suitable vehicle issues as is known in the art. Thus, the tire safety monitoring line device 100 can alert a user to specific areas of their tire tread 104 that is worn down more than other areas, allowing a user to not only replace their tires 106, but also correct any alignment issues, brake issues, etc., or any other suitable vehicle issues as is known in the art.

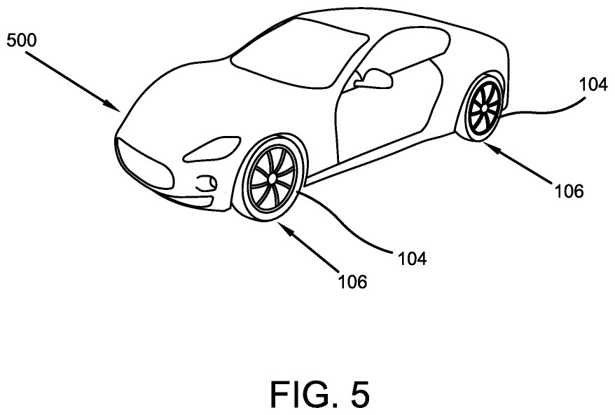

FIG. 5 illustrates a perspective view of one embodiment of the tire safety monitoring line device 100 of the present invention in use on a vehicle 500. In operation, the tire safety monitoring line device 100 allows for the continuous and automatic monitoring of a user's tire tread. The device 100 comprises a plurality of dye-filled or paint-filled capsules 102 embedded within the tire tread 104 at differing tread levels based on a user's wants and/or needs. The dye-filled or paint-filled capsules 102 are comprised of a variety of different colors and sizes as is known in the art and are created using standard encapsulation and sealing methods for soft capsule shells. Once embedded, the tire tread 104 wears down, exposing the capsules 102, which break open releasing dye or paint. Thus, the dye released, indicates differing tread levels, which alerts a user as to the tire tread level of their vehicle tire 106. The device 100 eliminates the need for expensive tools and time-consuming processes, and allows any vehicle owner, commercial or personal vehicles 500, to easily and efficiently monitor tire tread 104.

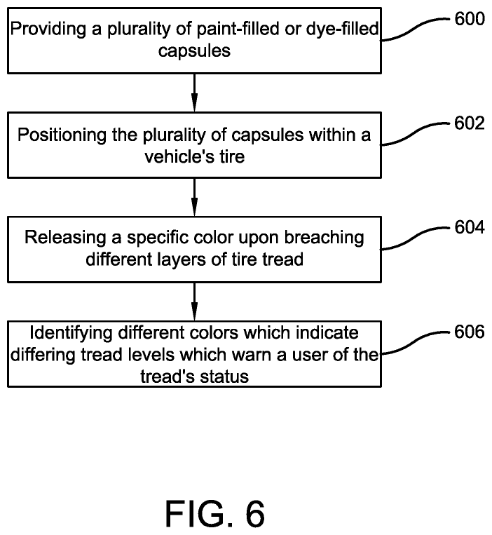

FIG. 6 illustrates a flowchart of the method of continuously and automatically monitoring a user's tire tread. The method includes the steps of at 600, providing a plurality of paint-filled or dye-filled capsules, wherein the dye or paint is encapsulated with a soft capsule shell by any suitable method known in the art, such as via a standard rotary die soft gelatin capsule machine, a plate process, a seamless capsule machine, or a non-standard rotary die machine. The soft capsule shell then utilizes high frequency, ultrasonic, or induction welding to seal the capsules. The method also comprises at 602, positioning the plurality of capsules within a vehicle's tire tread, such that the plurality of capsules are stacked within different layers of tire tread. Further, the method comprises at 604, releasing a specific color upon breaching different layers of tire tread. The capsules are exposed when the tire tread is worn low, therefore breaking open and releasing the dye once contact has occurred. Finally, at 606, identifying different colors which indicate differing tread levels, which warn a user of the tread's status.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “tire safety monitoring line device”, “tire tread monitoring device”, and “device” are interchangeable and refer to the tire safety monitoring line device 100 of the present invention.

Notwithstanding the forgoing, the tire safety monitoring line device 100 of the present invention can be of any suitable size and configuration as is known in the art without affecting the overall concept of the invention, provided that it accomplishes the above-stated objectives. One of ordinary skill in the art will appreciate that the tire safety monitoring line device 100 as shown in FIGS. 1-6 is for illustrative purposes only, and that many other sizes and shapes of the tire safety monitoring line device 100 are well within the scope of the present disclosure. Although the dimensions of the tire safety monitoring line device 100 are important design parameters for user convenience, the tire safety monitoring line device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A tire safety monitoring line device for automatically and continuously monitoring a tire tread of a vehicle tire, the tire safety monitoring line device comprising:
a plurality of dye-filled capsules;
wherein the plurality of dye-filled capsules are used in conjunction with the vehicle tire;
wherein the vehicle tire comprises a plurality of tread layers; and
wherein the plurality of dye-filled capsules are embedded within at least one of the plurality of tread layers of the vehicle tire.

2. The tire safety monitoring line device of claim 1, wherein the plurality of dye-filled capsules comprise paint.

3. The tire safety monitoring line device of claim 1, wherein the plurality of dye-filled capsules are embedded into the plurality of tread layers.

4. The tire safety monitoring line device of claim 3, wherein the plurality of dye-filled capsules are manufactured using an encapsulation method.

5. The tire safety monitoring line device of claim 4, wherein the encapsulation method is a select one of a standard rotary die soft gelatin capsule machine, a plate process, a seamless capsule machine, and a non-standard rotary die machine that utilizes extrusion technology.

6. The tire safety monitoring line device of claim 5, wherein once encapsulated, the plurality of dye-filled capsules utilizes a high frequency, an ultrasonic or an induction welding to seal the plurality of dye-filled capsules to prevent leakage.

7. The tire safety monitoring line device of claim 6, wherein the tire safety monitoring line device is manufactured from an acrylonitrile-butadiene-styrene (ABS).

8. The tire safety monitoring line device of claim 7, wherein as the plurality of tread layers wear down from the vehicle tire being driven, the plurality of dye-filled capsules are exposed and will break open to release a dye contained therein.

9. The tire safety monitoring line device of claim 8, wherein the plurality of dye-filled capsules comprise different colors of the dye.

10. The tire safety monitoring line device of claim 9, wherein the different colors of dye identify a specific tread layer in the plurality of tread layers.

11. The tire safety monitoring line device of claim 10 further comprising a plurality of rubber levels having differing colors, such that as the plurality of tread layers are worn down, the plurality of rubber levels having differing colors are exposed.

12. A tire safety monitoring line device comprising:
a vehicle tire comprised of a plurality of tread layers; and
a plurality of dye-filled capsules embedded in the plurality of tread layers of the vehicle tire at differing tread levels of the vehicle tire.

13. The tire safety monitoring line device of claim 12, wherein the plurality of dye-filled capsules comprise different colors of dye.

14. The tire safety monitoring line device of claim 13, wherein the different colors of dye identify a specific tread layer of the plurality of tread layers.

15. The tire safety monitoring line device of claim 14, wherein, as each of the plurality of tread layers begin to wear down, at least one of the plurality of dye-filled capsules will break open and release a colored dye.

16. A method of continuously and automatically monitoring a status of a tire tread on a vehicle tire comprising the steps of:
providing a plurality of dye-filled capsules;
positioning the plurality of dye-filled capsules within the tire tread of the vehicle tire at a plurality of different layers;
releasing a specific color of dye from the plurality of dye-filled capsules upon breaching a select one of the plurality of different layers; and
using the specific color of dye to warn the user of the status of the tire tread on the vehicle tire.

17. The method of claim 16, wherein the specific color of dye is encapsulated with a soft capsule shell by a select one of a standard rotary die soft gelatin capsule machine, a plate process, a seamless capsule machine, or a non-standard rotary die machine.

18. The method of claim 17 further comprising a step of using a select one of a high frequency, an ultrasonic, or an induction welding to seal the plurality of dye-filled capsules.

19. The method of claim 18, wherein the plurality of dye-filled capsules are stacked within the plurality of different layers of the tire tread of the vehicle tire.

20. The method of claim 19, wherein when the tire tread is worn down a predetermined amount, at least one of the plurality of dye-filled capsules is exposed and then broken to release a dye.
